(19) United States
(12) Patent Application Publication
(10) Pub. No.: US 2021/0378232 A1
(43) Pub. Date: Dec. 9, 2021

(54) Game Call

(71) Applicants: Weston Delzer, SE Max, ND (US); Waylon Delzer, SE Max, ND (US)

(72) Inventors: Weston Delzer, SE Max, ND (US); Waylon Delzer, SE Max, ND (US)

(21) Appl. No.: 16/893,350

(22) Filed: Jun. 4, 2020

(51) Int. Cl. A01M 31/00

(52) U.S. Cl. CPC A01M 31/004

(57) ABSTRACT

The present disclosure is directed to a game call that can be used to attract, mimic, or communicate with game animals. The game call comprises a plurality of components including an insulating component comprising heat insulating properties. The insulating component is disposed in a location on the game call that provides insulation, in particular, to critical components located in interior portions of the game call. The insulating part may provide insulation to interior parts of the game call including reeds and other critical interior parts of the game call.

### CROSS REFERENCE TO RELATED APPLICATIONS

This application claims priority under 35 USC § 119(e) to U.S. Provisional Application No. 62/816,297 filed Mar. 11 2019, which is herein incorporated by reference in its entirety.

### BACKGROUND OF THE DISCLOSURE

### Field of the Invention

This invention is generally directed to game calls, more specifically, game calls including outer insulation layers.

### Description of the Related Art

Game calls frequently suffer from the problem of moisture, including saliva, freezing around a reed in the inner portion of the game call. Hunting is frequently conducted at temperatures that are below freezing. Under such conditions, moisture will freeze in the game call and thereby disrupt operation of the device. This is especially problematic in the portions of the game call that contain the reed which is frequently where moisture accumulates. When the reed freezes, the game call will generally become unusable.

Another frequent problem with game calls involves gripping the device. Many game calls are slippery, particularly in cold temperatures, and can be easily dropped or mishandled during use.

Accordingly, improved outer layers that can better insulate a game call in below freezing temperatures, and additionally provide benefits with respect to handling are needed.

### SUMMARY OF THE INVENTION

The present disclosure is directed to a game call that can be used to attract, mimic, or communicate with game animals. The game call comprises a plurality of components including an insulating component comprising heat insulating properties. The insulating component is disposed in a location on the game call that provides insulation, in particular, to critical components located in interior portions of the game call. The insulating part may provide insulation to interior parts of the game call including reeds and other critical interior parts of the game call.

The insulating component may also provide a better grip for the game call. Materials for the insulation layer can include insulating material such as silicon, rubber, or other rubber containing materials which can provide increased friction for better handling as well as insulation.

In addition, the present invention allows the ability to easily display logos and designs on the product. The present invention allows for an easier manufacturing process applying murders and designs onto the product. Furthermore, the present invention allows the personalization and customization of the appearance of the game call. It allows the game call to be customized in a plurality of styles that can be easily and conveniently interchanged on the game call.

Other features and aspects will be apparent from the following detailed description, the drawings, and the claims

### BRIEF DESCRIPTION OF THE DRAWINGS

FIG. 1 shows one embodiment of an exploded view of a game call 100 of the disclosure.

FIG. 2A shows an embodiment of a cross-section of a game call of the disclosure.

FIG. 2B shows a top-down view of an embodiment of a game call of the disclosure.

FIG. 3 shows another embodiment of a game call of the disclosure.

FIG. 4 shows another embodiment of a game call 400 of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

A wild game call is used to attract, mimic, or communicate with animals. The present disclosure relates to a game call that comprises insulating components. More specifically, the game call includes a part or a plurality of parts that include a material that has insulating properties. The parts comprising an insulating type material are disposed in a location which provides insulation to the game call including critical components in the inner portion of the game call which may be referred to as inner parts of the call or the sound producing assembly.

The insulating material part(s) may provide, but is not limited to, the following characteristics. The insulating material part(s) provide insulation to the inner parts of the game call including reeds, the “guts” of the game call, and other parts that may be found inside the call. The insulating material part(s) may provide a grip like feature to the game call. Insulating materials such as silicon, rubber, or rubber like similar materials including other polymeric materials that have good heat insulating properties, may be used as the insulating material which also provides a comfortable friction for increased grip properties.

In this respect, the game call may have a higher coefficient of friction with respect to a human hand than other surfaces of the game call which are usually plastic or wood. The coefficient of friction (COF), often symbolized by the Greek letter μ, is a dimensionless scalar value which describes the ratio of the force of friction between two bodies and the force pressing them together.

See e.g., https://en.wikipedia.org/wiki/Friction.

The insulating material part(s) may also be used for improving the aesthetic properties of the game call including but not limited to logos, model names, advertisement, and custom designs. The insulating part(s) may be easily replaceable and interchangeable with other similar insulating parts of different design, color, logo, etc. for purposes of personalization, customization, aesthetics, or improved function.

The insulating parts may wrap around a part of the game call including a central portion of the game call in a form fitting shape such that there is substantially no space between the insulating part and the game call.

The ‘central portion’ of a game call as that term is used herein includes the sound making assembly or the guts. In embodiments this would include a reed, a wedge, and a tone board. The sound making assembly may also be made in other ways and be of different configurations known and used in the art, for example, in some cases portions of the sound making assembly are made of a continuous part of components molded together. One example of a sound making assembly comprised of portions molded together is the “J-Frame” style call in which the part otherwise known as the “toneboard” is continuously molded into the exhaust portion of the game call. The insulating parts may elastically wrap around one more components of the game call.

The insulating parts may also wrap around other parts of the game call including an upper portion of the game call including a mouthpiece as well as a lower portion of a game call including an exhaust.

In embodiments, the insulating parts may range in size from approximately ¼ inches to approximately 5.0 inches wide, and 1/16 inches thick to ½ inches thick. The insulating parts may have a length of 1 inch to 10 inches with the length being defined as the circumference. The length can be provided in a manner that allows for the insulating part to elastically fit snugly around the circumference of the portion of the call in which the insulating part is disposed such that there is substantially no space between the insulating part(s) and the game call and the insulating part(s) substantially conform with the shape of the game call. Preferred dimensions of the insulating parts range in size from 0.5 to 2 inches width, 2 to 4 inches length (circumference), and 1/16 to ⅛ inches thick.

As mentioned, the insulating part may comprise silicone. In embodiments, the insulating part may be made wholly from silicone, i.e., consist essentially of silicone or consist entirely of silicone. A silicone or polysiloxane is generally any of a number of polymers that include any synthetic compound made up of repeating units of siloxane, which is a chain of alternating silicon atoms and oxygen atoms, combined with carbon, hydrogen, and sometimes other elements.

Silicones are generally of low heat conductivity and can serve as insulating materials. Silicones can also be rubber-like. Preferred silicones for the present disclosure would include silicones with low heat conductivity and good insulating properties and that are generally rubber like.

The insulating part may also comprise natural rubber in all it varieties. Natural rubber, typically comes from latex of Hevea brasiliensis, and is mainly poly-cis-isoprene.

The insulating part may also comprise synthetic rubber. Synthetic rubber, like other polymers, can be made from various petroleum-based monomers. The most prevalent synthetic rubber is styrene-butadiene rubbers (SBR) derived from the copolymerization of styrene and 1,3-butadiene. Other synthetic rubbers can include polyisoprene, prepared by polymerization of synthetic isoprene; and chloroprene, prepared by polymerization of 2-chlorobutadiene.

The insulating part may also include combinations of the above materials or any other polymeric material that has low heat conduction, good insulating properties, good frictional properties.

The insulating part may be made by known methods of manufacturing silicone or rubber bands such as wristbands, etc.

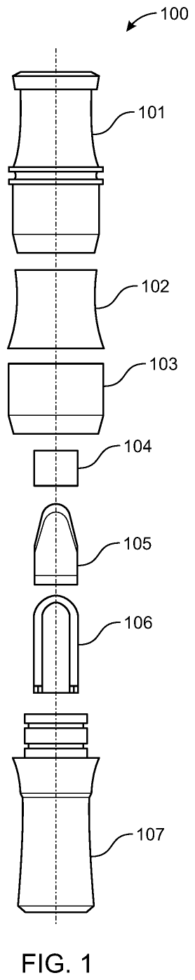

FIG. 1 shows one embodiment of an exploded view of a game call 100 of the disclosure. FIG. 1 shows upper portion 101, which may also be referred to as a mouthpiece, barrel, etc. Upper portion 101 may include a plastic or wood-based material or combinations thereof. FIG. 1 further shows insulating part 102 and insulating part 103. Insulating part 102 and insulating part 103 may preferably include silicon or rubber. Wedge 104 in FIG. 1 is included among the inner components of a game call and may comprise plastic. Reed 105 is also included among the inner components (or guts) of the game call and may comprise mylar in preferred embodiments. Reed 105 may also include other materials known in the art used in game call reeds. Tone board 106 is also included among the inner components of a game call and may comprise plastic. Lower portion 107 of game call of FIG. 1, which may also be referred to as an insert, exhaust, etc., may comprise plastic or a wood-based material, or combinations thereof. When the game call is blown into through the upper portion or mouthpiece the lower portion has an exit opening that serves as an exhaust.

The upper portion may include about ⅛ to about ⅔ of the total surface area of the game call.

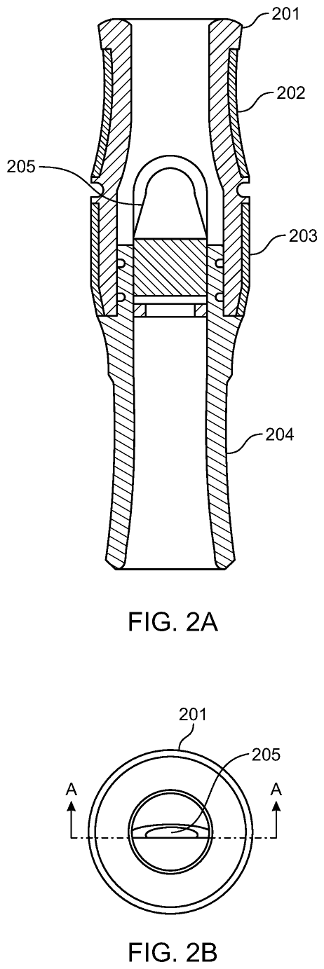

FIG. 2A shows an embodiment of a cross-section of a game call 200 of the disclosure. FIG. 2A shows upper plastic part 201 which may comprise a plastic material, for example, polycarbonate, or an acrylic material. FIG. 2A further shows insulating part 202 and insulating part 203. FIG. 2A further shows lower plastic part 204. Lower plastic part 204 may also be made of a plastic material, for example, polycarbonate, or an acrylic material. FIG. 2A also generally shows the inner portion or guts 205 of the game call.

FIG. 2B shows a top-down view of an embodiment of a game call of the disclosure. FIG. 2B shows an upper portion 201 and guts 205.

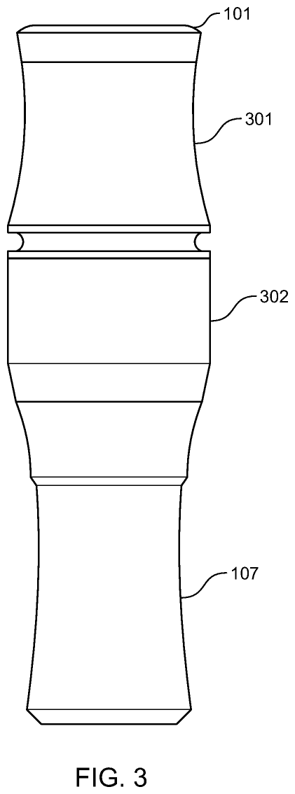

FIG. 3 shows another embodiment of a game call of the disclosure. FIG. 3 shows insulating part 301 and insulating part 302.

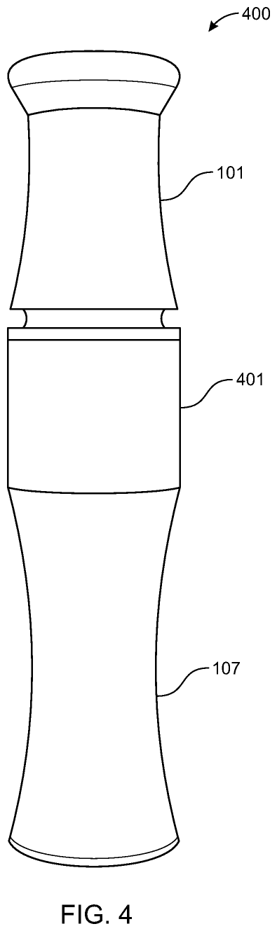

FIG. 4 shows another embodiment of a game call 400 of the disclosure. FIG. 4 shows insulating part 401.

While this disclosure includes specific examples, it will be apparent after an understanding of the disclosure of this application has been attained that various changes in form and details may be made in these examples without departing from the spirit and scope of the claims and their equivalents.

We claim:

1. A game call comprising:
an upper portion comprising a mouthpiece;
a central portion comprising a sound making assembly;
a lower portion comprising an exhaust; and
one or more insulating parts disposed on an outer surface of the game call;
wherein the one or more insulating part(s) comprise an insulating polymeric material and are elastically wrapped around an area including the central portion of the game call such that there is substantially no space between the insulating part(s) and the game call and the insulating part(s) substantially conform with the shape of the game call.

2. The game call of claim 1, wherein the insulating polymeric material comprises silicone or rubber.

3. The game call of claim 2, wherein the one or more insulating parts are elastically wrapped around the game call.

4. The game call of claim 3, wherein the one or more insulating parts are substantially wrapped around the upper portion and the central portion.

5. The game call of claim 4, wherein the one or more insulating parts are substantially wrapped around the central portion comprising the sound making assembly.

6. The game call of claim 1, wherein the one or more insulating parts have a higher coefficient of friction with respect to a human hand than other portions of the surface of the game call.

7. The game call of claim 1, wherein the insulating parts further comprise one or more logos or designs.

8. The game call of claim 1, wherein the insulating polymeric material comprises silicone.

9. The game call of claim 3, wherein one or more insulating parts are substantially wrapped around the central portion and the lower portion.

10. The game call of claim 1, wherein the insulating parts are removable and/or replaceable.
